(19) United States
(12) Patent Application Publication
(10) Pub. No.: US 2012/0192604 A1
(43) Pub. Date: Aug. 2, 2012

(54) Door Lock

(76) Inventor: Robert Simmering, Bennett, CO (US)

(21) Appl. No.: 13/194,129

(22) Filed: Jul. 29, 2011

Related U.S. Application Data
(60) Provisional application No. 61/369,857, filed on Aug. 2, 2010.

(51) Int. Cl. E05B 65/06; E05B 45/06; E05B 45/00

(52) U.S. Cl. 70/466

(57) ABSTRACT

A door lock has a fixed housing having a thin pie shape with a hinge sleeve extending from an edge and an extension containing a hinge opening. The hinge opening connects to a hinge of a door. A rotating housing has a thin pie shape with a hinge sleeve extending from an edge and aligned with the hinge sleeve of the fixed housing. A hinge pin extends through the hinge sleeve of the fixed housing and the hinge sleeve of the rotating housing. The rotating housing has a first position that is coplanar with the fixed housing and a second position that is stacked on the fixed housing. When the rotating housing is in the first position it blocks a door from opening. Since the fixed housing is attached to the hinge of the door, the door lock is as strong as the door itself.

### RELATED APPLICATIONS

The present invention claims priority on provisional patent application Ser. No. 61/369,857, filed on Aug. 2, 2010, entitled “Door Lock” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

There have been a number of locks for doors. Most standard doors have locks in the handle. However, these can often be opened with a credit card or the lock can be popped. Many people install chain locks to provide an extra layer of protection. However, these locks are just held in place with relatively small screws and so these locks can easily forced open. Another door lock is the deadbolt. Deadbolts cannot be opened with a credit card and they are harder to force open than chain locks. However, a determined burglar can pry open a door with a deadbolt or the lock can be popped.

Thus there exists a need for a door lock that cannot be pried open and the lock cannot be popped.

### BRIEF SUMMARY OF INVENTION

A door lock that overcomes these and other problems includes a fixed housing having a thin pie shape with a hinge sleeve extending from an edge and an extension containing a hinge opening. The hinge opening connects to a hinge of a door the owner wants to lock. A rotating housing has a thin pie shape with a hinge sleeve extending from an edge and aligned with the hinge sleeve of the fixed housing. A hinge pin extends through the hinge sleeve of the fixed housing and the hinge sleeve of the rotating housing. A set screw extends through the rotating housing and parallel to the hinge pin. The rotating housing has a first position that is coplanar with the fixed housing and a second position that is stacked on the fixed housing. When the rotating housing is in the first position it blocks a door from opening. Since the fixed housing is attached to the hinge of the door, the door lock is as strong as the door itself.

In one embodiment, the door lock includes an alarm. The alarm determines if the door lock is not in the first position. It may determine this with a proximity switch. The proximity switch is connected to an audible or visual indicator. In one embodiment, the proximity switch may be connected to an alarm system, such as a monitoring service or a whole house alarm system.

### BRIEF DESCRIPTION OF THE SEVERAL VIEWS OF THE DRAWINGS

FIG. 1 is a top left perspective view of a door lock in accordance with one embodiment of the invention;

FIG. 2 is an exploded view of a door lock in accordance with one embodiment of the invention;

FIG. 3 is a top view of a door lock in accordance with one embodiment of the invention;

FIG. 4 is a side view of a door lock in a first position in accordance with one embodiment of the invention;

FIG. 5 is a side view of a door lock in a second position in accordance with one embodiment of the invention; and

FIG. 6 is a circuit diagram of an alarm in accordance with one embodiment of the invention.

### DETAILED DESCRIPTION OF THE INVENTION

The invention relates to a door lock that includes a fixed housing having a thin pie shape with a hinge sleeve extending from an edge and an extension containing a hinge opening. The hinge opening connects to a hinge of a door the owner wants to lock. A rotating housing has a thin pie shape with a hinge sleeve extending from an edge and aligned with the hinge sleeve of the fixed housing. A hinge pin extends through the hinge sleeve of the fixed housing and the hinge sleeve of the rotating housing. A set screw extends through the rotating housing and parallel to the hinge pin. The rotating housing has a first position that is coplanar with the fixed housing and a second position that is stacked on the fixed housing. When the rotating housing is in the first position it blocks a door from opening. Since the fixed housing is attached to the hinge of the door, the door lock is as strong as the door itself.

FIG. 1 is a top left perspective view of a door lock 10 in accordance with one embodiment of the invention. The door lock 10 has a fixed housing 12 with a hinge opening 14 that fits on a door hinge. A moveable housing 16 is connected to the fixed housing 12 by a hinge 19. The moveable housing 16 has a set screw 18 that runs through the housing 16. The fixed housing 12 has a pie or quarter circle shape with an extension 20 that includes the hinge opening 14. The moveable housing has a pie or quarter circle shape.

Note that the drawings depict a lock for a door with the hinges on the left side, but the invention also encompasses a lock for a door with hinges on the right side of the door. The right side door lock is essentially a mirror image of the one depicted as should be apparent to those skilled in the art.

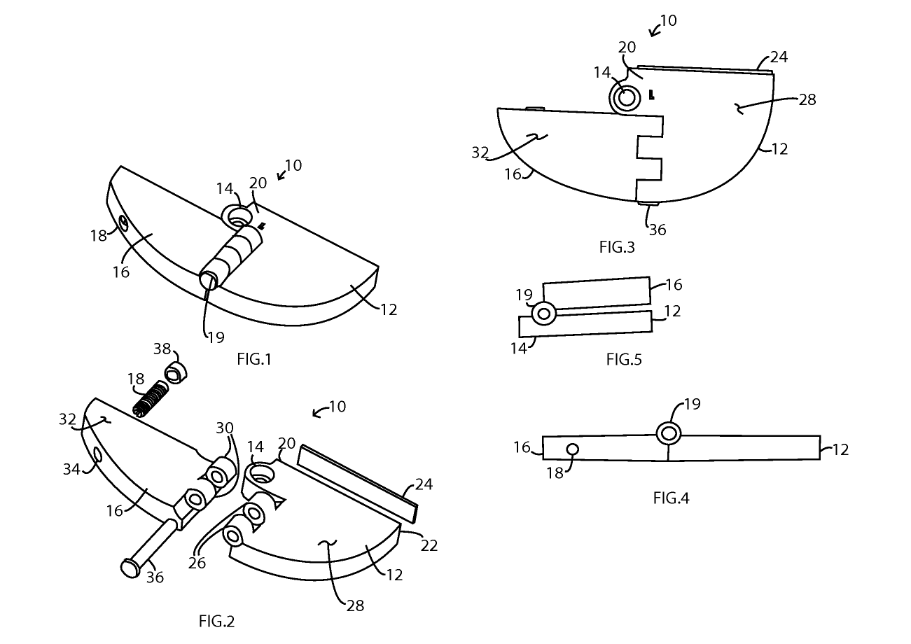

FIG. 2 is an exploded view of a door lock 10 in accordance with one embodiment of the invention. The attached planar housing 12 has an edge 22 to which a pad 24 is attached. Generally, the pad 24 is adjacent to or in contact with a door jamb and the rubber bumper ensures that there is no scuffing or damage to the door jamb. The attached planar housing 12 has a pair of hinge sleeves 26 on one edge of the housing 12. The hinge sleeves 26 extend above a top surface 28 the housing 12. The rotating planar housing 16 has a pair of hinge sleeves 30 on an edge of the housing 16. The hinge sleeves 30 extend above a top surface 32 of the housing 16. The set screw 18 screws into a male opening(s) 34 of the housing 16 and is parallel to a hinge pin 36. A bumper 38 fits over the end of the set screw 18. The set screw is adjusted so that the bumper 38 normally touches or is adjacent to the door being locked. The hinge sleeves 26 interleave with the hinge sleeves 30 and the hinge pin 36 fits through the hinge sleeves 26, 30. Note that in one embodiment, the housings 12, 16 are hollowed out on the bottom surface.

FIG. 3 is a top view of a door lock 10 in accordance with one embodiment of the invention. This view shows the door lock 10 in a first position or locked position. In this position the fixed housing 12 and the moveable housing 16 are coplanar. Since the fixed housing 12 is attached to the door hinge by hinge opening 14, the door is blocked from opening by the moveable hinge 16 and the door cannot be opened.

FIG. 4 is a side view of a door lock 10 in a first position in accordance with one embodiment of the invention. The first position is the locked position and the housings 12, 16 are coplanar.

FIG. 5 is a side view of a door lock 10 in a second position in accordance with one embodiment of the invention. In the second position the fixed housing 12 and the moveable housing 16 are stacked. In the second position, the moveable housing 16 no longer blocks the door and the door can be opened normally.

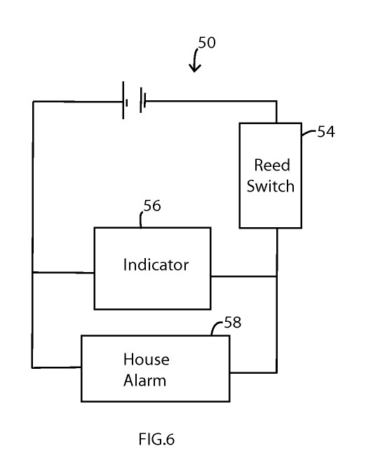

FIG. 6 is a circuit diagram of an alarm 50 in accordance with one embodiment of the invention. The alarm 50 includes a battery or other power source 52. The power source 52 is connected to a reed switch or other proximity switch 54. The switch 54 is in series with an indicator 56 and a house alarm 58 in one embodiment. The indicator 56 may be a speaker or a light or both. The house alarm 58 may be a whole house alarm or may be a remote monitoring service or both. In one embodiment, the connection to the house alarm is wireless. In one embodiment, the reed switch is attached to the underside of the moveable housing 16 and the alarm includes an on/off switch. When the housing 16 is in the locked position (See FIG. 4) then the reed switch 54 is open and alarm does not sound. When the moveable housing is moved from the locked position the reed switch closes and the indicator, such as an audible alarm sounds. The battery and the audible alarm may be attached to the underside of the moveable housing 16 or may be attached to the door or door jamb.

Thus there has been describe a simple effective door lock that that cannot be pried open and the lock cannot be popped.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A door lock comprising:
a fixed housing having a hinge opening for mating with a door hinge;
a moveable housing; and
a hinge connecting an edge of the fixed housing to the edge of the moveable housing.

2. The door lock of claim 1, further including a set screw extending through the moveable housing.

3. The door lock of claim 1, wherein the fixed housing has a hinge sleeve that extends above a top surface of the fixed housing.

4. The door lock of claim 3, wherein the moveable housing has a hinge sleeve that extends above a top surface of the moveable housing.

5. The door lock of claim 1, wherein the moveable housing has a top surface that is in the shape of a quarter of a circle.

6. The door lock of claim 5, wherein the fixed housing has a top surface in the shape of a quarter of a circle with an extension that includes the hinge opening.

7. The door lock of claim 1, further including an alert.

8. The door lock of claim 7, wherein the alert includes an audible indicator.

9. The door lock of claim 8, wherein the alert includes a sensor.

10. A door lock comprising:
an attached planar housing having a hinge opening and a hinge sleeve on an edge of the attached planar housing;
a rotating planar housing having a hinge sleeve on an edge of the rotating planar housing; and
a hinge pin extending through the hinge sleeve of the attached planar housing and the hinge sleeve of the rotating planar housing.

11. The door lock of claim 10, further including a set screw extending through the rotating planar housing and parallel to the hinge pin.

12. The door lock of claim 10, further including an alarm system.

13. The door lock of claim 12, wherein the alarm system includes a proximity switch.

14. The door lock of claim 13, wherein the alarm system includes an indicator in communication with the proximity switch.

15. The door lock of claim 10, wherein the rotating planar housing has a first position that is coplanar with the attached planar housing and a second position where the rotating planar housing is parallel with the attached planar housing.

16. A door lock comprising:
a fixed housing having a thin pie shape with a hinge sleeve extending from an edge and an extension containing a hinge opening, wherein the hinge opening connects to a hinge of a door;
a rotating housing having a thin pie shape with a hinge sleeve extending from an edge and aligned with the hinge sleeve of the fixed housing;
a hinge pin extending through the hinge sleeve of the fixed housing and the hinge sleeve of the rotating housing;
a set screw extending through the rotating housing and parallel to the hinge pin; and
wherein the rotating housing has a first position that is coplanar with the fixed housing and a second position that is stacked on the fixed housing.

17. The door lock of claim 16, further including an alarm that indicates if the rotating housing is not in the first position.
